(19) United States
(12) Patent Application Publication
(10) Pub. No.: US 2022/0095063 A1
(43) Pub. Date: Mar. 24, 2022

(54) METHOD FOR OPERATING A HEARING DEVICE AND HEARING SYSTEM

(71) Applicant: Sivantos Pte. Ltd., Singapore (SG)

(72) Inventors: Stefan Aschoff, Eckental (DE); Markus Mueller, Schwaig (DE)

(21) Appl. No.: 17/479,107

(22) Filed: Sep. 20, 2021

(30) Foreign Application Priority Data
Sep. 18, 2020 (DE) 10 2020 211 740.3

(51) Int. Cl. H04R 25/00

(52) U.S. Cl. CPC H04R 25/558; H04R 2225/61; H04R 25/603

(57) ABSTRACT

In a method for operating a hearing device, an activation gesture of a user is detected by a sensor, and a control gesture of the user is detected by the sensor or a further sensor. A setting parameter of the hearing device is changed in dependence on the control gesture. The change of the setting parameter is only performed if the activation gesture and the control gesture are detected within a predetermined time window.

### CROSS-REFERENCE TO RELATED APPLICATION

This application claims the priority, under 35 U.S.C. § 119, of German patent application DE 10 2020 211 740.3, filed Sep. 18, 2020; the prior application is herewith incorporated by reference in its entirety.

### FIELD AND BACKGROUND OF THE INVENTION

The invention relates to a method for operating a hearing device. Furthermore, the invention relates to a hearing system having such a hearing device.

Hearing devices are typically used to output a sound signal to the sense of hearing of the wearer (or user) of this hearing device. The output is carried out by means of an output transducer, usually acoustically via airborne sound by means of a loudspeaker (also referred to as a “receiver”). Such hearing devices are frequently used here as so-called hearing aid devices (also in short: hearing aids). For this purpose, the hearing devices normally comprise an acoustic input transducer (in particular a microphone) and a signal processor, which is configured to process the input signal (also: microphone signal) generated by the input transducer from the ambient sound with application of at least one typically user-specific saved signal processing algorithm in such a way that a hearing impairment of the wearer of the hearing device is at least partially compensated for. In particular in the case of a hearing aid device, the output transducer can be a speaker or in the alternative a bone conduction hearing aid or a cochlear implant, which are configured for the mechanical or electrical coupling of the sound signal into the sense of hearing of the wearer. The term hearing devices also includes in particular those devices such as, e.g., so-called tinnitus maskers, headsets, headphones, and the like.

Hearing devices in the form of hearing aids usually have at least two operating modes in which the microphone signals are processed differently. In an omnidirectional mode, incident sound is processed identically independently of its direction. This has the advantage that hardly any information is lost for the wearer. However, this omnidirectionality is often rather annoying if speech is present, since speech sound is then regularly overlaid by other noises and is thus less comprehensible to a wearer having a hearing impairment. Therefore, in such a case a directional effect is set in which spatial regions from which no speech sound is expected are suppressed or at least damped. Monaural directional microphones or also binaural directional microphones (i.e., formed by offsetting microphone signals from hearing aids worn on the left and right) are used for this purpose. In a simple embodiment, the spatial offset of two microphones in relation to one another is utilized for this purpose, in that they are electrically interconnected with one another and one of the microphone signals is delayed by a—usually settable—delay time. A spatial direction from which noises are to be suppressed or damped can thus be specified.

Above all in situations having multiple speakers, the selection of the direction which is to acquire the actual speaker can be comparatively complex. In a simple embodiment, the direction of the highest (microphone or reception) sensitivity is oriented frontally forward viewed from the user, so that the user has to look directly at the corresponding speaker (or: interlocutor). This has been recognized to be problematic, for example, when eating, since when bringing food to the mouth, the head of the user is usually turned away from the interlocutor. To remedy such problems, for example, control applications for smart phones or the like are known in which the user can set a desired direction on a type of virtual compass rose which is related to the personal zero degree direction of the user. This setting is then transferred to the hearing aid. Other settings—tone, volume, and the like—can usually also be performed using such a control application.

### SUMMARY OF THE INVENTION

The invention is based on the object of improving the setting of a hearing device.

This object is achieved according to the invention by a method having the features of the independent method claim. Furthermore, this object is achieved according to the invention by a hearing system having the features of the independent hearing system claim. Advantageous embodiments and refinements of the invention, which are partially inventive per se, are described in the dependent claims and the following description.

The method according to the invention is used for operating a hearing device. According to the method, an activation gesture carried out by a user of the hearing device is detected by means of a sensor here. In addition, a touchless control gesture of the user is detected by means of this or a further sensor. In other words, this control gesture is detected in a touchless manner. A setting parameter of the hearing device is thereupon changed in dependence on the control gesture. However, the change of the setting parameter is only performed if the activation gesture and the control gesture are detected within a predetermined time window.

For example, one to five, preferably two to four seconds are set as the duration of the time window.

The detection or recognition of the activation gesture and in particular also the control gesture is preferably carried out on the basis of a pattern recognition, for example, by means of a comparison of the sensor signal of the corresponding sensor to a predetermined reference signal.

Because two gestures, namely the activation gesture and the control gesture, are required for the change or adjustment of the setting parameter, particularly reliable recognition of a control intention of the user is enabled and, vice versa, the risk of an incorrect recognition is accordingly reduced. Moreover, the use of gestures to control the hearing device enables particularly intuitive and simple operation of the hearing device, in particular without additional control means, for example, a remote control (optionally installed as an application on a smart phone), having to be used.

Furthermore, a touch-sensitive sensor, which is installed in particular in the hearing device, is used as the sensor for detecting the activation gesture. For example, a structure-borne sound sensor, by means of which a “shock” of the hearing device due to the touch can be detected, is used as such a touch-sensitive sensor. Alternatively, a proximity sensor, for example, a capacitive sensor is used. In one preferred variant, a type of “double-click”, in particular thus two touches in rapid succession (i.e., for example, offset by up to one second) of the hearing device is used as the activation gesture here. This also enables a comparatively unambiguous recognition of the activation gesture and differentiation thereof from an inadvertent touch, for example, when running the hand through the hair.

Moreover, a microphone system of the hearing device is used as a further sensor. In this case, a predetermined sound, which is generated in particular using a hand (in particular of the user) is used as the touchless control gesture. Preferably a finger snap, rubbing the hands, or a clap (which preferably corresponds to a predetermined pattern) is used as such a sound. Alternatively, a predetermined, in particular sudden speech sound, i.e., in particular a clicking, popping, or smacking sound, a sequence of “hard” sounds such as “pt” or the like is used. The use of the microphone system of the hearing device has the advantage here that such a microphone system is provided in any case in a hearing device, in particular a hearing aid device.

In one preferred method variant, the setting parameter of the setting is adjusted (i.e., changed) in such a way that a directional effect (also referred to as “directionality”) of the hearing device is oriented differently. In particular, for this purpose a finger snap is detected as a sound generated using a hand and also a spatial direction is derived on the basis of the finger snap, in particular from which the sound of the finger snap arrives at the microphone system. The directional effect is thereupon preferably set in such a way that it points in the ascertained spatial direction. A directional lobe (optionally of multiple directional lobes) of the microphone system (which is operated in particular in a directional mode) is preferably oriented in this spatial direction for this purpose. The user of the hearing device can thus change the directional effect of his hearing device using comparatively simple gestures.

The spatial direction, from which the sound of the finger snap arrives on the microphone system is preferably ascertained by means of the determination of a so-called “direction of arrival”. In the case of a binaural hearing aid system, which comprises one hearing device assigned to the left ear and one to the right ear of the user, in this case, for example, a difference of a runtime is determined, with which a sound pulse corresponding to the finger snap arrives on the respective microphone system of the left and right hearing device. A spatial angle can be derived from this difference in a fundamentally known manner, from which the sound pulse originates. In principle, however, the direction of arrival can also be determined in a comparable way in a single hearing device which has two microphones.

In a further expedient method variant, the directional effect which has been adjusted as described above due to the control gesture is tracked. I.e., the directional effect, in particular the directional lobe, is held oriented constantly in the spatial direction from which the finger snap was detected. This is advantageous in particular in a conversation situation, since the user of the hearing device thus always has his “acoustic attention” oriented in the same direction, for example, on an interlocutor, even if he turns his head (for example again and again at the dining table) away from his interlocutor.

In one method variant, which is alternative to the above invention and forms an independent invention (alternatively to the above-described acoustic detection of the control gesture and optionally also to the detection of the activation gesture on the basis of a touch), a camera system is used as the sensor (for detecting the activation gesture) or as the further sensor. For example, this camera system is associated with a device with which the hearing device (or the above-mentioned binaural hearing aid system) is or can be in a communication connection. In a variant, this camera system is incorporated, for example, into a pair of glasses referred to as “smart glasses”. In a further variant, a camera system of a motor vehicle which is configured and provided to acquire gestures for controlling the motor vehicle is used as the camera system.

For the case that the above-mentioned camera system is used to acquire at least the control gesture, preferably a predetermined hand movement is used as the control gesture. To change the directional effect, preferably a pointer, for example “pointing” or indicating with outstretched index finger in the desired spatial direction is used.

To change other setting parameters, for example, the volume, a thumb oriented upward (for “louder”) or a thumb oriented downward (for “softer”) is used, for example. For example, raising or lowering the flat, outstretched hand is used to raise or lower “bass ranges”.

As described above, the recognition of the control gestures is also carried out by means of pattern recognition or the like in the case of such optical detection.

For the case in which the activation gesture is also optically detected, a predetermined movement of a body part of the user is accordingly used as the activation gesture. For example, such a movement is a predetermined hand movement or—in particular in the case of the smart glasses—a predetermined eye movement, for example, blinking twice.

In one expedient method variant, additionally or alternatively to the adjustment of the directional effect (as indicated above) upon the detection of the control gesture, the volume of the tones output by means of the hearing device is changed, a bass range is raised or lowered, or a ratio of speech comprehension to “euphony” is changed (for example to improve the audibility of music). For this purpose, the corresponding setting parameter—thus, for example, a volume value, an amplification factor for the bass range, or the like—is adjusted accordingly.

For example, the above-described clapping or hand rubbing are used as “acoustic control gestures” for the above-described additional or alternative changes of the corresponding setting parameter or parameters.

In one expedient method variant, a deactivation gesture is detected by means of the sensor or the further sensor and the adjustment of the setting parameter is thereupon reversed. For the case in which the above-described double-click (thus the “double tap”) on the hearing device is used as the activation gesture, for example, a triple click (thus in particular tapping three times on the hearing device within a predetermined time window) is assessed as a deactivation gesture.

The hearing system according to the invention has the above-described hearing device, optionally two of the hearing devices forming the above-mentioned hearing aid system. Furthermore, the hearing system has a sensor system for detecting the above-described activation gesture and the above-described (touchless) control gesture and in particular also the deactivation gesture. The sensor system preferably includes the above-described sensor or sensors. Moreover, the hearing system has a controller, which is generally configured here—by programming and/or circuitry—for the purpose of carrying out the above-described method according to the invention, preferably independently. The controller is thus specifically configured to detect the activation gesture by means of a sensor of the sensor system and (in particular by means of this or the further sensor of the sensor system) to detect the control gesture, thereupon to change the (optionally corresponding) setting parameter of the hearing device in dependence on the control gesture, and to perform the change of the setting parameter only if the activation gesture and the control gesture have been detected within the predetermined time window.

In one preferred embodiment, at least the core of the controller is formed here by a microcontroller having a processor and a data memory, in which the functionality for carrying out the method according to the invention is implemented by programming in the form of operating software (also: firmware), so that the method—as described in interaction with the user—is carried out automatically in the microcontroller upon execution of the operating software. The controller is alternatively formed by a nonprogrammable electronic component, for example an ASIC, in which the functionality for carrying out the method according to the invention is implemented using circuitry means.

The method according to the invention and the hearing system according to the invention therefore have the same features and advantages.

Other features which are considered as characteristic for the invention are set forth in the appended claims.

Although the invention is illustrated and described herein as embodied in a method for operating a hearing device and a hearing system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, side view showing a hearing device according to the invention; and

FIG. 2 is a flow chart showing a method carried out by the hearing device.

### DETAILED DESCRIPTION OF THE INVENTION

Parts corresponding to one another are always provided with identical reference signs in all figures.

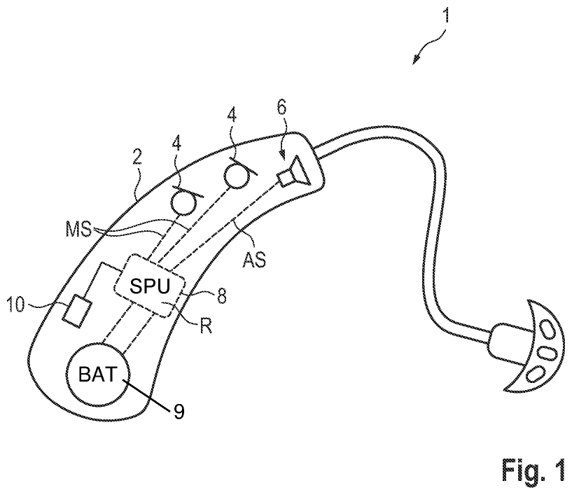

Referring now to the figures of the drawings in detail and first, particularly to FIG. 1 thereof, there is shown a hearing device 1 in the form of a hearing aid device 1, specifically a hearing aid device 1 to be worn behind the ear of a user (also referred to in short as a hearing aid, here as “BTE 1”). The BTE 1 contains a housing 2, in which electronic components of the BTE 1 are arranged. These electronic components are, for example, two microphones 4, a loudspeaker 6, a signal processor 8, and a battery module 9. The microphones 4 are used in the intended operation of the BTE 1 for receiving ambient sound and converting it into electrical input signals (also: “microphone signals MS”), which are processed (in particular filtered, amplified and/or damped depending on frequency, etc.) by the signal processor 8 (also referred to as “controller”). The processed input signals are subsequently output as output signals AS at the loudspeaker 6 and converted thereby into sound signals and passed on to the sense of hearing of the user.

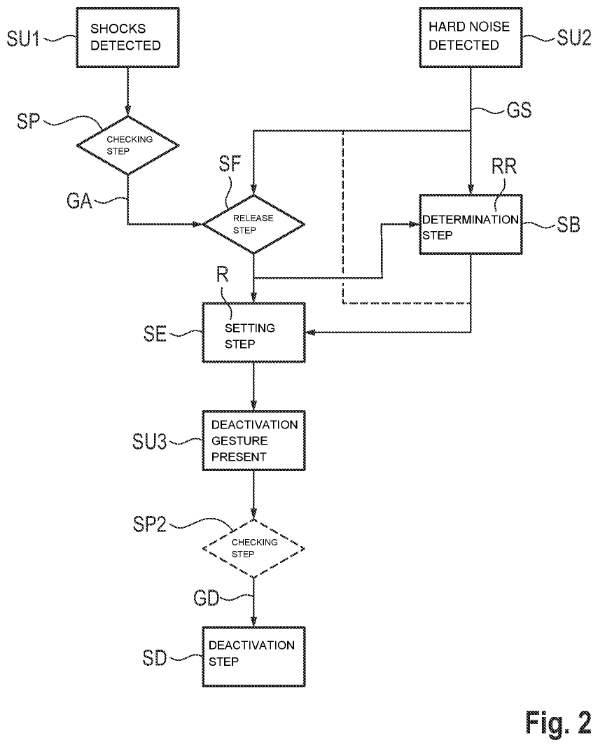

To generate a directional effect, the signal processor 8 is configured to mix the microphone signals MS of both microphones 4 with one another. To generate, for example, a directional effect oriented forward (and thus a suppression or damping of noises arriving from the rear), for example, the microphone signal MS of the rear microphone 4 in the intended wearing state (the left microphone in the illustration according to FIG. 1) is subjected to a delay (which corresponds here to the sound runtime between the two microphones 4) and subtracted from the microphone signal MS of the front microphone 4. The signal processor 8 is additionally configured to orient the directional effect, specifically a so-called directional lobe, in space by means of a directional parameter R. In addition, the signal processor 8 is configured to change the orientation of the directional effect (and thus the directional value) specifically to the user and situation. To enable a particularly user-friendly adjustment of the directional effect here, the signal processor 8 is configured to carry out a method described in more detail hereinafter on the basis of FIG. 2. For this purpose, the BTE 1 has a touch-sensitive sensor, here a structure-borne sound sensor (also: acceleration sensor) 10, which is interconnected with the signal processor 8.

The signal processor 8 monitors, by means of the structure-borne sound sensor 10, the BTE 1 for shocks which do not originate from the intended wearing of the BTE 1 in a monitoring step SU1. Such shocks are often induced here by touches of the BTE 1 by the user and are used, for example, for the input of “commands”. If a shock is registered, the signal processor 8 checks in a checking step SP whether this shock corresponds to a predetermined pattern, specifically a signal pattern here, which corresponds to two tap touches in rapid succession (for example within 0.5 seconds), comparable to a double-click in a computer mouse. If this is the case, the signal processor 8 assesses this as an activation gesture GA. The structure-borne sound sensor 10 is therefore used as a touch-sensitive sensor.

By means of the microphone system formed from the two microphones 4, the signal processor 8 monitors in a further monitoring step SU2 whether a sharp or hard noise which corresponds to a finger snap with respect to the signal pattern is received. For this purpose, it is checked whether the microphone signals MS contain a sound pulse, in particular an approximately rectangular or at least rapidly rising signal peak. If this is the case, the noise corresponding to the finger snap is interpreted as a (touchlessly emitted) control gesture GS of the user.

In a first variant, the signal processor 8 checks in a release step SF upon the reception of the finger snap (i.e., the control gesture GS) whether the activation gesture GA was also detected within a predetermined time period (for example of up to 5 seconds) before or after the control gesture GS. In both cases, the adjustment of the directional effect (specifically of the directional parameter R, which represents a setting parameter influencing the directional effect) is enabled. For the case in which the activation gesture GA was detected before the control gesture GS—the user thus first tapped the BTE 1 and subsequently snapped the fingers—an “actual” or “classical” activation of the adjustment of the directional effect thus exists, in the reverse case, therefore a subsequent release or authorization.

If the adjustment of the directional effect is enabled, in a determination step SB, a spatial direction RR is ascertained from the microphone signals MS, from which the noise of the finger snap has arrived on the microphone system. For this purpose, a “direction of arrival” is ascertained. Optionally, in addition to the illustrated BTE 1, two BTE 1 configured and used for binaural operation are used. In this case, the direction of arrival is ascertained by a runtime comparison between the two BTE 1.

In an optional variant (indicated by a dashed connecting arrow), the spatial direction RR is already ascertained before the release step SF.

In a setting step SE, the directional parameter R is subsequently adjusted so that a directional lobe of the directional microphone formed by means of the microphones 4 is oriented in the spatial direction RR.

To set the directional effect, the user of the BTE 1 thus only has to execute the activation gesture GA and the control gesture GS within the predetermined time period. As the control gesture GS, he snaps the fingers of the arm stretched or directed in the desired direction here.

The directional parameter R is used here as a dynamic value so that the directional effect, specifically the directional lobe, remains constantly directed in the spatial direction RR, even if the user and thus the BTE 1 moves. For this purpose, for example, a movement of the BTE 1 ascertained by means of the structure-borne sound sensor 10 (which is designed as an acceleration sensor) or another gyroscopic sensor is taken into consideration.

In a further monitoring step SU3, the BTE 1 is monitored as to whether a deactivation gesture GD is present, for example, a triple tap of the BTE 1. In this case, the adjustment of the directional effect is reset again (or also: reversed) in a deactivation step. The actual recognition of the deactivation gesture GD optionally takes place in a subsequent checking step SP2 (shown by dashed lines), comparable to the monitoring step SU1 and the checking step SP for detecting the activation gesture GA.

The subject matter of the invention is not restricted to the above-described exemplary embodiment. Rather, further embodiments of the invention can be derived by a person skilled in the art from the above description.

The following is a summary list of reference numerals and the corresponding structure used in the above description of the invention:
1 BTE
2 housing
4 microphone
6 loudspeaker
8 signal processor
9 Battery Module
10 structure-borne sound sensor
AS output signal
MS microphone signal
R directional parameter
RR spatial direction
SU1 monitoring step
SU2 monitoring step
SU3 monitoring step
SP checking step
SP2 checking step
SF release step
SB determination step
SE setting step
SD deactivation step
GA activation gesture
GS control gesture
GD deactivation gesture

1. A method for operating a hearing device, which comprises the steps of:
detecting an activation gesture of a user by means of a sensor being a touch-sensitive sensor of the hearing device;
detecting a touchless control gesture of the user by means of the sensor or a further sensor being a microphone system of the hearing device; and
changing a setting parameter of the hearing device in dependence on the touchless control gesture, wherein a change of the setting parameter is only performed if the activation gesture and the touchless control gesture are detected within a predetermined time window, and wherein a predetermined sound generated using a hand or a predetermined sudden speech sound is used as the touchless control gesture.

2. The method according to claim 1, wherein:
a finger snap is detected as the predetermined sound generated using the hand;
a spatial direction is derived on a basis of the finger snap; and
the setting parameter is adjusted in such a way that a directional effect of the hearing device points in the spatial direction.

3. The method according to claim 2, wherein the directional effect is tracked.

4. The method according to claim 1, which further comprises adapting the setting parameter in such a way that a volume of tones output by means of the hearing device is changed, a bass range is raised or lowered, or a ratio of speech comprehension to euphony is changed.

5. The method according to claim 1, which further comprises detecting a deactivation gesture by means of the sensor or the further sensor, and wherein the adjusting of the setting parameter is thereupon reversed.

6. The method according to claim 1, wherein:
the touch-sensitive sensor is a structure-borne sound sensor or a proximity sensor; and
the predetermined sound generated is a finger snap, a rubbing of the hands, or a clap.

7. A hearing system, comprising:
a hearing device having a sensor system for detecting an activation gesture and a control gesture, said sensor system having a touch-sensitive sensor and a microphone system, said hearing device further having a controller for performing a method of operating said hearing device, said controller configured to:
detect the activation gesture of a user by means of said touch-sensitive sensor;
detect the control gesture of the user by means of said touch-sensitive sensor or said microphone system; and
change a setting parameter of said hearing device in dependence on the control gesture, wherein a change of the setting parameter is only performed if the activation gesture and the control gesture are detected within a predetermined time window, and wherein a predetermined sound generated using a hand or a predetermined sudden speech sound is used as the control gesture.
